(19) United States
(12) Patent Application Publication
(10) Pub. No.: US 2022/0183279 A1
(43) Pub. Date: Jun. 16, 2022

(54) STABILIZED THIOKETONE FORMULATIONS

(71) Applicant: Bayer Aktiengesellschaft, Leverkusen (DE)

(72) Inventors: Christoph SCHOTES, Duesseldorf (DE); Jens KRAUSE, Leverkusen (DE); Martin WEISS, Bornheim/Sechtem (DE)

(21) Appl. No.: 17/440,075

(22) PCT Filed: Mar. 17, 2020
(86) PCT No.: PCT/EP2020/057189

§ 371 Date: Sep. 16, 2021

(30) Foreign Application Priority Data
Mar. 19, 2019 (EP) 19163615.8

(51) Int. Cl. A01N 25/22; A01N 43/653; A01N 43/56; A01N 25/04

(52) U.S. Cl. CPC A01N 25/22; A01N 25/04; A01N 43/56; A01N 43/653

(57) ABSTRACT

The invention relates to storage-stable prothioconazole-containing formulations with specific antioxidants and having a particularly low content of 2-(1-chlorocyclopropyl)-1-(2-chlorophenyl)-3-(1H-1,2,4-triazol-1-yl)propan-2-ol, to a process for their preparation, to a method for controlling phytopathogenic fungi in crop protection and to their use as crop protection agents.

The present invention relates to stabilised formulations of thioketones (thiones), in particular of active ingredients containing thione building blocks, especially triazolinethiones, as functional groups.

The present invention relates in particular to storage-stable formulations containing thiones, e.g. prothioconazole or 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile, which formulations have a particularly low content of the corresponding dethio compounds, e.g. 2-(1-chlorocyclopropyl)-1-(2-chlorophenyl)-3-(1H-1,2,4-triazol-1-yl)propan-2-ol.

The present invention furthermore relates to a process for preparing the formulations mentioned above, to a method for controlling phytopathogenic fungi in crop protection, and to the use of the formulations as crop protection compositions.

In addition, the present invention relates to formulations comprising certain antioxidants, in particular formulations comprising vitamin C (ascorbic acid) and/or tocopherol (vitamin E), of thione compounds, in particular of agrochemically active ingredients having thione groups, and to the use of certain antioxidants, in particular vitamin C and tocopherols (vitamin E) for stabilising thione compounds, in particular agrochemically active ingredients having thione groups.

It is already known that, for example, prothioconazole can be used in standard formulations for control of fungi (WO-A 96/16 048). This active ingredient is 2-[2-(1-chlorocyclopropyl)-3-(2-chlorophenyl)-2-hydroxypropyl]-2,4-dihydro-3H-1,2,4-triazole-3-thione. Prothioconazole-containing formulations are generally liquid formulations and are supplied on the market, for example, in the form of emulsion concentrates.

Furthermore, it is known that the active ingredient prothioconazole can be degraded under particular conditions to give the compound 2-(1-chlorocyclopropyl)-1-(2-chlorophenyl)-3-(1H-1,2,4-triazol-1-yl)propan-2-ol (PSM-Zulassungsbericht [Crop Protection Agent Registration Report], Tilmor, 2010 Aug. 30, serial no. 21, German Federal Office of Consumer Protection and Food Safety).

Therefore, prothioconazole (hereinbelow referred to as PTZ)-containing formulations, as early as in the course of production, may contain a certain amount of 2-(1-chlorocyclopropyl)-1-(2-chlorophenyl)-3-(1H-1,2,4-triazol-1-yl)propan-2-ol. In the case of storage under severe conditions, such as elevated temperatures, incidence of light and intensive oxygen contact, it is likewise possible for degradation of prothioconazole to take place to give 2-(1-chlorocyclopropyl)-1-(2-chlorophenyl)-3-(1H-1,2,4-triazol-1-yl)propan-2-ol, as a result of which the proportion of active ingredient in the formulations is correspondingly reduced. Since the compound 2-(1-chlorocyclopropyl)-1-(2-chlorophenyl)-3-(1H-1,2,4-triazol-1-yl)propan-2-ol (hereinbelow referred to as dethio) is a relevant impurity, the content thereof in prothioconazole-containing formulations is subject to regulatory limitation. This also applies analogously to other thione-containing compounds such as 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile.

Here, the maximum permissible amount of dethio in PTZ formulations depends on the amount of PTZ in the formulation in g/l. The maximum permissible amount of dethio is given in ppm, with the permissible proportion of dethio in ppm being half of the value of the PTZ load in g/l. Thus, the maximum permissible dethio content in a formulation with 100 g/l PTZ is 50 ppm (=0.005% by weight).

WO-A 2012/033590 discloses aqueous dispersions of prothioconazole containing a sulfur compound, for example L-cysteine, for stabilization.

WO 2017/097882 and WO2018/228885 describe stabilised PTZ-containing formulations which can be considered to be the closest prior art. What is described therein are emulsion concentrates and suspension concentrates comprising PTZ dissolved in a solvent. It was possible to stabilize the formulation by addition of compounds of the formula (I)

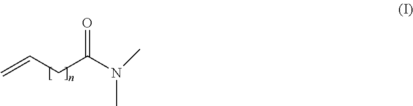

in which
n represents 3, 4, 5, 6, 7, 8, 9, 10, 11, 12, 15 or 18
and to achieve a reduction of the dethio content.

Compounds of the formula (I) are known from WO-A 2012/061094 and can be prepared by the process of metathesis. These are, for example, products from Stepan ((N,N-dimethyl 9-decenamide, CAS number: 1356964-77-6, Hallcomid® 1025 or Steposol® MET-10U).

These compounds have the disadvantage that they require very large amounts of up to 30% of stabiliser to achieve a desired effect, which represents a mayor modification of the formulation. Also, these are novel additives which, in some cases, still require approval for use in crop protection formulations.

There is therefore a need for stable PTZ-comprising formulations which, even over prolonged periods and under unfavourable storage conditions such as exposure to oxygen, high temperatures or the action of light, effectively suppress or prevent the degradation of the thiones, in particular the triazolinthiones and especially of PTZ to the corresponding dethio products, e.g. 2-(1-chlorocyclopropyl)-1-(2-chlorophenyl)-3-(1H-1,2,4-triazol-1-yl)propan-2-ol (compound III), and are at the same time acceptable for agrochemical use or do not face any regulatory barriers.

It was thus an object of the invention to provide novel, improved thione-containing formulations which have high storage stability and do not exhibit any significant degradation rates of thiones to the corresponding dethio products, in particular of prothioconazole to 2-(1-chlorocyclopropyl)-1-(2-chlorophenyl)-3-(1H-1,2,4-triazol-1-yl)propan-2-ol.

Furthermore, it was an object of the present invention to provide stabilisers and/or stabiliser systems for thiones, which stabilisers are suitable for use in agrochemical formulations and highly effective even in small amounts.

Furthermore, it was found that the degradation of thiones to dethio products is easily triggered by light, inter alia of certain wavelengths. Surprisingly, it was however found that, here, conventional UV blockers or UV absorbers are only insufficiently effective.

In addition, it was found that even various commercial antioxidants do not provide effective protection against degradation of the thiones but, rather, even promote degradation.

Surprisingly, it has been found that even very small amounts of certain antioxidants such as ascorbic acid and tocopherols (vitamin E) markedly effectively prevent the degradation of thiones, in particular of prothioconazole, to dethio products.

The present invention therefore provides formulations comprising
a) an active ingredient, preferably an agrochemically active ingredient, having a thione group and
b) at least one compound selected from the group of the antioxidants comprising ascorbic acid, tocotrienol, tocopherol (e.g. (+)-delta-tocopherol, (+/−)-alpha-tocopherol), mixtures of tocopherols, thiolactic acid, butylated hydroxytoluene BHT, eugenol, caffeic acid (3,4-dihydroxycinnamic acid), mercaptopropionic acid and D,L-thiothreitol, and mixtures of these compounds.

The formulations are preferably agrochemical formulations.

In a further preferred embodiment, the active ingredient a) having a thione group is selected from the group comprising prothioconazole and 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile, particularly preferably only prothioconazole.

Furthermore, the active ingredient is preferably present in an amount of from 1% by weight to 50% by weight, more preferably from 4% by weight to 30% by weight, and particularly preferably from 5% by weight to 28% by weight, based on the total weight of the formulation.

The antioxidant b) is more preferably from the group comprising vitamin C (ascorbic acid) and tocopherol and tocotrienol (preferably (+)-delta-tocopherol, (+/−)-alpha-tocopherol, (+)-alpha-tocopherol and vitamin E and mixtures of tocopherols). Furthermore, in aqueous formulations preference is given to ascorbic acid, whereas in formulations with organic solvent preference is given to tocopherols.

Vitamin E is a collective term for fat-soluble substances having antioxidative action, with tocopherol and tocotrienol being the most frequently encountered forms. Hereinbelow, the term vitamin E is meant to comprise alpha-tocopherol (RRR-α-tocopherol or D-α-T0), beta-tocopherol, gamma-tocopherol, delta-tocopherol, alpha-tocotrienol, beta-tocotrienol, gamma-tocotrienol, delta-tocotrienol, and also their derivatives such as, for example, acetates.

Independently of the formulation type, the antioxidants are preferably present in an amount of from 0.01% by weight to 15.00% by weight, more preferred from 0.03% by weight to 5.00% by weight, and particularly preferably from 0.2% by weight to 4% by weight, based on the total weight of the formulation.

Depending of the formulation, e.g. water- or oil-based, preference is given to using water- or oil-soluble antioxidants, preferably in the following amounts:

SC Formulations:

In SCs, the antioxidants are preferably present in an amount of from 0.01% by weight to 10.00% by weight, more preferably from 0.03% by weight to 5% by weight, even more preferably from 0.03% by weight to 1.00% by weight and particularly preferably from 0.05% by weight to 0.5% by weight, based on the total weight of the formulation.

OD and EC Formulations:

In ODs, the antioxidants are preferably present in an amount of from 0.10% by weight to 5.00% by weight, more preferably from 0.2% by weight to 4.00% by weight, and particularly preferably from 0.2% by weight to 3% by weight, based on the total weight of the formulation.

In ECs, the antioxidants are preferably present in an amount of from 0.50% by weight to 15.00% by weight, more preferred from 1% by weight to 10.00% by weight, and particularly preferably from 3% by weight to 10% by weight, based on the total weight of the formulation.

Prothioconazole (with the chemical name 2-[2-(1-chlorocyclopropyl)-3-(2-chlorophenyl)-2-hydroxypropyl]-1,2-dihydro-3H-1,2,4-triazole-3-thione) (CAS number 178928-70-6) takes the form of a racemate. Suitable processes for preparation thereof are described in DE-A 195280. Prothioconazole may be present in the thiono form of the general formula (II)

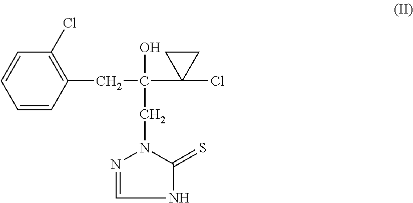

or in the tautomeric mercapto form of the general formula (IIa).

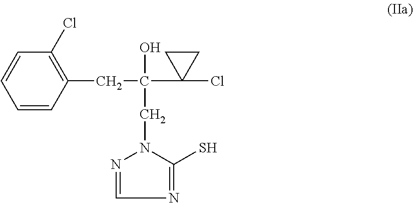

The use of the term “prothioconazole” hereinafter always covers the isomers shown here and further possible tautomers.

2-(1-Chlorocyclopropyl)-1-(2-chlorophenyl)-3-(1H-1,2,4-triazol-1-yl)propan-2-ol is also present as a racemate and has the general formula (III), where in turn all tautomeric forms are to be embraced by this representation.

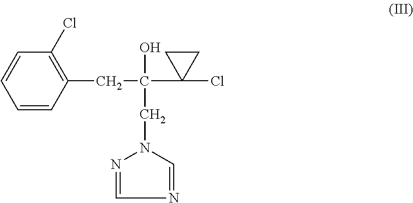

Furthermore, the formulations according to the present invention, as described above, may each comprise further ingredients, such as:
c) c1: non-ionic dispersant/emulsifier,
c2: ionic dispersant/emulsifier
d) other active agrochemical ingredients different from a)
e) solvents including OD carriers
f) carriers (WGs, and also Aerosils for SC/TC/WG)
g) g1: organic thickeners
g2: inorganic thickeners
h) further additives and auxiliaries.

Formulation types are defined by the FAO and are found at www.fao.org/ag/agp/agpp/pesticid. In the March 2016 edition, the customary formulation types are described on pages 66-231. The formulation according to the invention is a customary formulation type described by the FAO. Examples which may be mentioned here are suspension concentrates (SC), and also colorant-containing concentrates for seed treatment (FS), emulsion concentrates (EC), water-dispersible concentrates (WG), oil dispersions (OD), suspoemulsions (SE), aqueous emulsions (EW), microemulsions (ME) and liquid formulations (SL). Preferred are EC, SC, FS, SE, OD and WG formulation types, very particular preference being given to formulations where at least one active ingredient is not dissolved. Very particular preference is given to FS, SC, SE, OD and WG formulations, most preferably SC, FS and WG formulations.

The present invention further provides for the use of the formulations of the invention for treatment of plants and corresponding methods.

### Nonionic Emulsifiers and Dispersants c1)

Useful nonionic emulsifiers and dispersants c1), such as emulsifiers, wetting agents, surfactants and dispersers, include standard surface-active substances present in formulations of active agrochemical ingredients. Examples include ethoxylated nonylphenols, reaction products of linear or branched alcohols with ethylene oxide and/or propylene oxide, ethylene oxide-propylene oxide block copolymers, end group-capped and non-end group-capped alkoxylated linear and branched, saturated and unsaturated alcohols (e.g. butoxy polyethylenepropylene glycols), reaction products of alkylphenols with ethylene oxide and/or propylene oxide, ethylene oxide-propylene oxide block copolymers, polyethylene glycols and polypropylene glycols, and also fatty acid esters, fatty acid polyglycol ether esters, alkylsulfonates, alkylsulfates, arylsulfates, ethoxylated arylalkylphenols, for example tristyrylphenol ethoxylate having an average of 16 ethylene oxide units per molecule, and also ethoxylated and propoxylated arylalkylphenols, and also sulfated or phosphated arylalkylphenol ethoxylates or ethoxy- and propoxylates. Particular preference is given to tristyrylphenol alkoxylates and fatty acid polyglycol ether esters. Very particular preference is given to tristyrylphenol ethoxylates, tristyrylphenol ethoxy propoxylates and castor oil polyglycol ether esters, in each case individually or in mixtures. Additives may additionally be useful, such as surfactants or esters of fatty acids, which contribute to improvement in biological efficacy. Suitable nonionic emulsifiers and dispersants c1) are, for example, Soprophor® 796/P, Lucramul® CO30, Lucramul® HOT, Lucramul® PSI 100 or Synperonic® T304.

Suitable nonionic dispersers c1) may likewise be selected from the group comprising polyvinylpyrrolidone (PVP), polyvinyl alcohol, copolymer of PVP and dimethylaminoethyl methacrylate, butylated PVP, copolymer of vinyl chloride and vinyl acetate, and partially hydrolyzed vinyl acetate, phenolic resins, modified cellulose types, for example Luviskol® (polyvinylpyrrolidone), Mowiol® (polyvinyl alcohol) or modified cellulose. Preference is given to polyvinylpyrrolidone types, particular preference to types of low molecular weight such as Luviskol® K30 or Sokalan® K30.

Useful further nonionic emulsifiers and dispersants c1) from the group of the di- and triblock copolymers of alkylene oxides are, for example, compounds based on ethylene oxide and propylene oxide, having mean molar masses between 200 and 10 000 and preferably 1000 to 4000 g/mol, where the proportion by mass of the polyethoxylated block varies between 10 and 80%, for example the Synperonic® PE series (Uniqema), the Pluronic® PE series (BASF), the VOP® 32 or Genapol® PF series (Clariant).

The proportion of nonionic emulsifiers and dispersants c1) required in the suspension concentrates according to the invention is preferably 1% to 15% by weight, more preferably 2% to 10% by weight and particularly preferably 2.5% to 8% by weight.

### Anionic Emulsifiers and Dispersants c2)

Suitable anionic emulsifiers and dispersants b1), such as emulsifiers, surfactants, wetting agents and dispersers, are, for example, alkali metal, alkaline earth metal or ammonium salts of sulfonates, sulfates, phosphates, carboxylates and mixtures thereof, for example the salts of alkylsulfonic acids or alkylphosphoric acids and alkylarylsulfonic or alkylarylphosphoric acids, diphenylsulfonates, alpha-olefinsulfonates, lignosulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols or of fatty acid esters. Examples of phosphates are phosphate esters. Examples of carboxylates are alkyl carboxylates and carboxylated alcohol ethoxylates or alkylphenol ethoxylates. Likewise suitable is the group of anionic emulsifiers of the alkali metal, alkaline earth metal and ammonium salts of the polystyrenesulfonic acids, salts of the polyvinylsulfonic acids, salts of the alkylnaphthalenesulfonic acids, salts of alkylnaphthalenesulfonic acid-formaldehyde condensation products, salts of condensation products of naphthalenesulfonic acid, phenolsulfonic acid and formaldehyde. Examples are calcium dodecylbenzenesulfonate such as Rhodocal® 70/B (Solvay), Phenylsulfonat CA100 (Clariant) or isopropylammonium dodecylbenzenesulfonates such as Atlox® 3300B (Croda).

Further typical representatives include Phenylsulfonat CA (calcium dodecylbenzenesulfonate), Soprophor® products (optionally esterified derivatives of tristyrylphenol ethoxylates), Emulsogen® 3510 (alkylated EO/PO copolymer), Emulsogen® EL 400 (ethoxylated castor oil), Tween® products (fatty acylated sorbitan ethoxylates), Calsogen® AR 100 (calcium dodecylbenzenesulfonate). Preference is given to combinations of salts of alkylated aromatic sulfonic acids, such as calcium phenylsulfonate and/or Calsogen® AR 100, with alkylated copolymers of ethylene oxide and propylene oxide, such as Emulsogen® 3510. Particular preference is given to combinations of salts of dodecylbenzenesulfonic acid, such as Calsogen® AR 100, with alkylated copolymer of ethylene oxide and propylene oxide, such as Emulsogen® 3510.

Examples of further anionic emulsifiers and dispersants c2) from the group of the naphthalenesulfonates are Galoryl® MT 800 (sodium dibutylnaphthalenesulfonate), Morwet® IP (sodium diisopropylnaphthalenesulfonate) and Nekal® BX (alkylnaphthalenesulfonate). Examples of anionic surfactants from the group of the condensates of naphthalenesulfonates with formaldehyde are Galoryl® DT 201 (naphthalenesulfonic acid hydroxy polymer with formaldehyde and methylphenol sodium salt), Galoryl® DT 250 (condensate of phenol- and naphthalenesulfonates), Reserve® C (condensate of phenol- and naphthalenesulfonates) or Morwet® D-425, Tersperse® 2020. Preference is given to 1,2-dibutyl- or -diisobutyl-substituted naphthalenesulfonates, for example products such as Galoryl® MT 800 (CFPI-Nufarm) and Nekal® BX (BASF). Further typical surfactants are Soprophor® 3D33, Soprophor® 4D384, Soprophor® BSU, Soprophor® CY/8 (Solvay) and Hoe® 53474, and in the form of the Sapogenat® T products (Clariant), for example Sapogenat® T 100.

The proportion of anionic emulsifiers and dispersants c2) required in the technical concentrates according to the invention is preferably 2% to 35% by weight, more preferably 3% to 30% by weight, even more preferably 5% to 25% by weight and particularly preferably 10% to 20% by weight.

The proportion of anionic emulsifiers and dispersants c2) required in the suspension concentrates according to the invention is preferably 0.1% to 10% by weight, more preferably 0.2% to 7% by weight and particularly preferably 0.3% to 4% by weight.

### Further Active Agrochemical Ingredients Different from PTZ d)

Further active agrochemical ingredients d) in the context of the present invention are active fungicidal, insecticidal or herbicidal ingredients. In an alternative embodiment, the formulation of the invention comprises one or more further active insecticidal or fungicidal ingredients d), more preferably one or more active fungicidal ingredients d). The active ingredients used are preferably water-insoluble.

The Pesticide Manual provides a review of typical crop protection agents.

Preferred insecticidal components d) are, for example, imidacloprid, nitenpyram, acetamiprid, thiacloprid, thiamethoxam, clothianidin, cyantraniliprole, chlorantraniliprole, flubendiamide, tetraniliprole, cyclaniliprole, spirodiclofen, spiromesifen, spirotetramat, abamectin, acrinathrin, chlorfenapyr, emamectin, ethiprole, fipronil, flonicamid, flupyradifurone, indoxacarb, metaflumizone, methoxyfenozide, milbemycin, pyridaben, pyridalyl, silafluofen, spinosad, sulfoxaflor, triflumuron, the compound from WO-A 2006/089633 as Example I-1-a-4, the compound disclosed in WO-A 2008/067911 as Example I-1-a-4, the compound disclosed in WO 2013/092350 as Example Ib-14, the compound disclosed in WO 2010/51926 as Example Ik-84.

Preferred fungicidal components d) are, for example, bixafen, bixlozone, fenamidone, fenhexamid, fluopicolide, fluopyram, fluoxastrobin, isoflucypram, iprovalicarb, isotianil, isopyrazam, pencycuron, penflufen, propineb, tebuconazole, trifloxystrobin, ametoctradin, amisulbrom, azoxystrobin, benthiavalicarb-isopropyl, benzovindiflupyr, boscalid, carbendazim, chlorothanonil, cyazofamid, cyflufenamid, cymoxanil, cyproconazole, difenoconazole, ethaboxam, epoxiconazole, famoxadone, fluazinam, fluquinconazole, flusilazole, flutianil, fluxapyroxad, isopyrazam, kresoxim-methyl, lyserphenvalpyr, mancozeb, mandipropamid, metconazol, pyriofenone, folpet, metaminostrobin, oxathiapiprolin, penthiopyrad, picoxystrobin, probenazole, proquinazid, pydiflumetofen, pyraclostrobin, sedaxane, spiroxamin, tebufloquin, tetraconazole, valiphenalate, zoxamide, ziram, N-(5-chloro-2-isopropylbenzyl)-N-cyclopropyl-3-(difluoromethyl)-5-fluoro-1-methyl-1H-pyrazole-4-carboxamide, N-(5-chloro-2-isopropylbenzyl)-N-cyclopropyl-3-(difluoromethyl)-5-fluoro-1-methyl-1H-pyrazole-4-carboxamide, 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenylmethane-sulfonate, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr).

Particularly preferred fungicidal mixing partners d) for prothioconazole are, for example: tebuconazole, spiroxamin, bixafen, fluoxastrobin, trifloxystrobin, N-(5-chloro-2-isopropylbenzyl)-N-cyclopropyl-3-(difluoromethyl)-5-fluoro-1-methyl-1H-pyrazole-4-carboxamide, (3S,6S,7R,8R)-8-benzyl-3[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr) and fluopyram.

Very particular preference is given to the mixtures of a) (prothioconazole) with one or more compounds selected from the group of the compounds d):
a)+d) tebuconazole;
a)+d) trifloxystrobin;
a)+d) fluoxastrobin;
a)+d) bixafen;
a)+d) bixlozone;
a)+d) isoflucypram;
a)+d) fluopyram;
a)+d) spiroxamine;
a)+d) fluoxastrobin+trifloxystrobin;
a)+d) trifloxystrobin+spiroxamine;
a)+d) bixafen+tebuconazole;
a)+d) bixafen+fluoxastrobin;
a)+d) bixafen+trifloxystrobin;
a)+d) bixafen+spiroxamine;
a)+d) bixafen+fluopyram;
a)+d) tebuconazole+spiroxamine;
a)+d) tebuconazole+fluopyram;
a)+d) N-(5-chloro-2-isopropylbenzyl)-N-cyclopropyl-3-(difluoromethyl)-5-fluoro-1-methyl-1H-pyrazole-4-carboxamide
a)+d) N-(5-chloro-2-isopropylbenzyl)-N-cyclopropyl-3-(difluoromethyl)-5-fluoro-1-methyl-1H-pyrazole-4-carboxamide+tebuconazole
a)+d) N-(5-chloro-2-isopropylbenzyl)-N-cyclopropyl-3-(difluoromethyl)-5-fluoro-1-methyl-1H-pyrazole-4-carboxamide+flupyram
a)+d) bixafen+(3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr)

The proportion of component d) in the formulations of the invention is preferably 1% by weight to 40% by weight, particularly preferably 3% by weight to 35% by weight.

### Solvents e)

The formulations may comprise solvents e), for example in the case of EC, OD or SE formulations.
aromatic hydrocarbon mixtures (preferably naphaline reduced), for example Solvesso®;
aromatic hydrocarbons, for example white spirit, petroleum, alkylbenzenes and spindle oil, xylene, toluene or alkylnaphthalenes;
aliphatic/cycloaliphatic hydrocarbons, for example mineral oils, hexane, heptane, octane, nonane, decane, cyclopentane, cyclohexane, decalin or white oil;
chlorinated aromatic or aliphatic hydrocarbons, for example chlorobenzene, chloroethylene, or methylene chloride, chloroform or tetrachloromethanes;
alcohols, for example methanol, ethanol, isopropanol, butanol, ethylene glycol, propylene glycol or benzyl alcohol;
ethers, for example tetrahydrofuran, tetrahydrofurfuryl alcohol, tetrahydropyran, 1,4-dioxanes, diethyl ether, methyl tert-butyl ether, dihexyl ether, dioctyl ether, didecyl ether, dibenzyl ether, dimethylisosorbide, diphenyl ether, ethyl phenyl ether, phenyl benzyl ether or anisole;
monoesters/diesters/glycerol esters, for example ethyl acetate, butyl propionate, pentyl propionate, benzyl acetate, benzyl benzoate, butyl benzoate, Rhodiasolv® Polarclean, Rhodiasolv® RPDE, methyl lactate, ethyl lactate, propyl lactate, butyl lactate, 2-ethylhexyl lactate, ethyl 3-ethoxypropionate (UCAR® Ester EEP, Dow Chemical Company), dimethyl succinate, diethyl succinate, dipropyl succinate, dimethyl adipate, diethyl adipate, dipropyl adipate, dimethyl glutarate, diethyl glutarate, dipropyl glutarate, bis(2-ethylhexyl) adipate, diisopropyl adipate, dimethyl 2-methylglutarate, dioctyl maleate, glycerol monoacetate, glycerol diacetate, glycerol triacetate, vegetable oils, for example rapeseed oil, sunflower oil, soya oil, castor oil or corn oil;
lactones, for example butyrolactone, alpha-methyl-gamma-butyrolactone, gamma-valerolactone or delta-valerolactone;
polyethylene/propylene oxides, for example monoethylene glycol, monoethylene glycol monomethyl ether, monoethylene glycol monoethyl ether, monoethylene glycol monopropyl ether, monoethylene glycol monobutyl ether, monoethylene glycol monopentyl ether, monoethylene glycol monohexyl ether, monoethylene glycol monophenyl ether, monoethylene glycol dimethyl ether, monoethylene glycol diethyl ether, monoethylene glycol dipropyl ether, monoethylene glycol dibutyl ether, monoethylene glycol dipentyl ether, monoethylene glycol dihexyl ether, monoethylene glycol diphenyl ether, and the longer ethylene glycol homologs thereof; monopropylene glycol, monopropylene glycol monomethyl ether, monopropylene glycol monoethyl ether, monopropylene glycol monopropyl ether, monopropylene glycol monobutyl ether, monopropylene glycol monopentyl ether, monopropylene glycol monohexyl ether, monopropylene glycol monophenyl ether, monopropylene glycol dimethyl ether, monopropylene glycol diethyl ether, monopropylene glycol dipropyl ether, monopropylene glycol dibutyl ether, monopropylene glycol dipentyl ether, monopropylene glycol dihexyl ether, monopropylene glycol diphenyl ether, and the longer propylene homologs thereof; monoethylene glycol monomethyl ether acetate, monoethylene glycol diacetate, and the longer ethylene glycol homologs thereof; monopropylene glycol monomethyl ether acetate, monopropylene glycol acetate, and the longer polypropylene glycol homologs thereof;
simple and substituted amines, for example diethylamines, triethylamines, diisopropylamines, diisopropylethylamines, monoethanolamines, diethanolamines, triethanolamines and more highly alkoxylated amines, anilines or dimethylanilines;
amides/ureas, for example N-formylmorpholine, N,N-dimethylformamide, N,N-dimethylacetamide, N,N-dimethylbenzamide, N,N-dimethyloctanamide, N,N-dimethyldecanamide, N,N-dimethyldec-9-en-1-amide, N,N-dimethyldodedecanamide, N,N-dimethyllactamide, N,N-decylmethylformamide, N-methyl-2-pyrrolidone, N-ethyl-2-pyrrolidone, N-propyl-2-pyrrolidone, N-butyl-2-pyrrolidone, N-pentyl-2-pyrrolidone, N-hexyl-2-pyrrolidone, N-heptyl-2-pyrrolidone, N-octyl-2-pyrrolidone, N-nonyl-2-pyrrolidone, N-decyl-2-pyrrolidone, N-undecenyl-2-pyrrolidone, N-dodecyl-2-pyrrolidone, N-methyl-2-piperidone, N-methylcaprolactam, N-octylcaprolactam, tetramethylurea, tetraethylurea, 1,3-dimethyl-2-imidazolidinone, 1,3,4-trimethyl-2-imidazolidinone, 1,3-dimethyl-3,4,5,6-tetrahydro-2(1H)-pyrimidinone, 1-heptyl-3-methyl-2-imidazolidinone, 1-heptyl-1,3-dihydro-3-methyl-2H-imidazol-2-one;
ketones, for example acetone, diacetone alcohol, methyl ethyl ketone, 2-pentanone, 3-pentanone, 2-hexanone, 3-hexanone, 2-heptanone, 3-heptanone, 4-heptanone, 2-octanone, 3-octanone, 4-octanone, methyl isopropyl ketone, methyl isobutyl ketone, methyl isopentyl ketone, ethyl isopropyl ketone, ethyl isobutyl ketone, ethyl isopentyl ketone, propyl isopropyl ketone, propyl isobutyl ketone, propyl isopentyl ketone, 3,3-dimethyl-2-butanone, 2,4-dimethyl-3-pentanone, 4,4-dimethyl-2-pentanone, 2,6-dimethyl-4-heptanone, 2,2,4,4-tetramethyl-3-pentanone, cyclopentanone, cyclohexanone cycloheptanone, cyclooctanone, 2,4,6-cycloheptatrien-1-one, acetophenone, propiophenone, 1-(4-methylphenyl)ethanone, 1-(4-ethylphenyl)ethanone, 2-methyl-1-phenyl-1-propanone, 1-(3-ethylphenyl)ethanone, 4-phenyl-2-butanone, 1-phenyl-2-propanone, 1-phenyl-2-butanone, 2-phenyl-3-butanone, butyrophenone or valerophenone.
nitriles, for example acetonitrile, propanenitrile, 2-methylpropanenitrile, butanenitrile, 3-methylbutanenitrile, pentanenitrile, 4-methylpentanenitrile, hexanenitrile, heptanenitrile, octanenitrile, nonanenitrile, decanenitrile, benzonnitrile, benzeneacetonitrile, pentanedinitrile, 2-methylpentanedinitrile, hexanedinitrile, heptanedinitrile, octanedinitrile or nonanedinitrile;
acetals, for example 1,1-dimethoxy methane; 1,1-dimethoxyethane; 1,1′-[methylenebis(oxy)]bisethane; 1,1-diethoxyethane; 1,1′-[methylenebis(oxy)]bispropane; 2,4,6,8-tetraoxanonane, 1,1′-[methylenebis(oxy)]bisbutane, 2-methyl-1-[(2-methylpropoxy)methoxy]propane, 2,4,6,8,10-pentaoxaundecane, 2,5,7,10-tetraoxaundecane, 1,3-dioxolane, 1,3-dioxane or 4-methyl-1,3-dioxane; orthoesters, for example 1,1,1-trimethoxymethane, 1,1,1-trimethoxyethane, 1,1,1-trimethoxypropane, 2-methoxy-1,3-dioxolane, 2-methoxy-2-methyl-1,3-dioxolane, 2-methoxy-2-methyl-1,3-dioxolane, 2-ethoxy-1,3-dioxolane, 2-ethoxy-2-methyl-1,3-dioxolane, 2-ethyl-2-methoxy-1,3-dioxolane, 2-methoxy-1,3-dioxane, 2-methoxy-2-methyl-1,3-dioxane or 2-ethoxy-1,3-dioxane;
carbonates, for example dimethyl carbonate, methyl ethyl carbonate, diethyl carbonate, dipropyl carbonate, diisopropyl carbonate, dibutyl carbonate, dipentyl carbonate, dihexyl carbonate, diheptyl carbonate, dioctyl carbonate, dinonyl carbonate, didecyl carbonate, ethylene carbonate, 4-methyl-1,3-dioxolan-2-one, 4-(methoxymethyl)-1,3-dioxolan-2-one, glycerol carbonate, butylene carbonate, 4,6-dimethyl-3-dioxan-2-one or dibenzyl carbonate;
phosphates, for example trimethyl phosphate, triethyl phosphate, tripropyl phosphate, tributyl phosphate, triisobutyl phosphate, tripentyl phosphate, trihexyl phosphate, tris(2-ethylhexyl) phosphate, tris(2-butoxyethyl) phosphate or triphenyl phosphate;
sulfoxides, for example dimethyl sulfoxide, diethyl sulfoxide, 1,1-dioxotetrahydrothiophene, 1,1-dioxotetrahydro-3-methylthiophene or 1,1-dioxotetrahydro-2,4-dimethylthiophene.

In addition, the formulations of the invention may optionally comprise liquid fillers e), for example vegetable or mineral oils or esters of vegetable or mineral oils. Suitable vegetable oils e) are all oils which can typically be used in agrochemicals and can be obtained from plants. Examples include sunflower oil, rapeseed oil, olive oil, castor oil, colza oil, corn oil, cottonseed oil, walnut oil, coconut oil and soya oil. Possible esters are, for example, ethylhexyl palmitate, ethylhexyl oleate, ethylhexyl myristate, ethylhexyl caprylate, isopropyl myristate, isopropyl palmitate, methyl oleate, methyl palmitate, ethyl oleate. Preference is given to rapeseed oil methyl ester and ethylhexyl palmitate. Possible mineral oils are Exxsol® D100 and white oils.

TABLE 1
Illustrative trade names and CAS numbers of preferred compounds e)

| Trade name | Company | General description | CAS No. |
|---|---|---|---|
| Sunflower oil | | Triglycerides of different | 8001-21-6 |
| | | C14-C18 fatty acids, | |
| | | predominantly | |
| | | unsaturated | |
| Rapeseed oil | | Triglycerides of different | 8002-13-9 |
| | | C14-C18 fatty acids, | |
| | | predominantly | |
| | | unsaturated | |
| Corn oil | | Triglycerides of different | 8001-30-7 |
| | | C14-C18 fatty acids, | |
| | | predominantly | |
| | | unsaturated | |
| Soya oil | | Triglycerides of different | 8001-22-7 |
| | | C14-C18 fatty acids, | |
| | | predominantly | |
| | | unsaturated | |
| Rice oil | | Triglycerides of different | 68553-81- |
| | | C14-C18 fatty acids, | 1 |
| | | predominantly | |
| | | unsaturated | |
| Radia ® 7129 | Oleon NV, | Ethylhexyl palmitate | 29806-73- |
| Crodamol ® | BE | | 3 |
| OP | Croda, UK | | |
| Radia ® 7331 | Oleon NV, | Ethylhexyl oleate | 26399-02- |
| | BE | | 0 |
| Radia ® 7128 | Oleon NV, | C12/C14 ethylhexyl | 29806-75- |
| | BE | myristate/laurate | 5 |
| Radia ® 7127 | Oleon NV, | Ethylhexyl laurate | 20292-08- |
| | BE | | 4 |
| Radia ® 7126 | Oleon NV, | C8/10 ethylhexyl | 63321-70- |
| | BE | caprylate/caprate | 0 |
| Estol ® 1514 | Croda | Isopropyl myristate | 110-27-0 |
| Radia ® 7104 | Oleon NV, | Caprylic and capric acid | 73398-61- |
| | BE | triglycerides, neutral | 5. 65381- |
| | | vegetable oil | 09-1 |
| Radia ® 7732 | Oleon NV, | Isopropyl palmitate | 142-91-6 |
| Crodamol ® | BE | | |
| IPM | Croda, UK | | |
| Radia ® 7060 | Oleon NV, | Methyl oleate | 112-62-9 |
| | BE | | |
| Radia ® 7120 | Oleon NV, | Methyl palmitate | 112-39-0 |
| | BE | | |
| Crodamol ® | Croda | Ethyl oleate | 111-62-6 |
| EO | | | |
| AGNIQUE | Clariant | rapeseed oil methyl ester | 67762-38- |
| ME ® 18 RD- | BASF | 3. 85586- | |
| F, Edenor ® | | 25-0 | |
| MESU | | | |
| Exxsol ® D100 | Exxon Mobil | Hydrotreating low boilers | 64742-47- |
| | | (petroleum) | 8 |
| Solvesso ® | ExxonMobil | Solvent naphtha | 64742-94- |
| 200ND | | (petroleum), heavy | 5 |
| | | aromatic, naphthalene- | |
| | | depleted | |
| Kristol ® M14 | Carless | White mineral oil | 8042-47-5 |
| Marcol ® 82 | ExxonMobil | (petroleum), C14-C30 | |
| Ondina ® 917 | Shell | branched and linear | |
| Exxsol ® | ExxonMobil | White mineral oil | 64742-46- |
| D130 | Total | (petroleum) | 7 |
| Banole ® 50 | | | |
| Genera ®-12 | Total | White mineral oil | 72623-86- |
| | | (petroleum) | 0 |
| Genera ®+0-9 | Total | White mineral oil | 97862-82- |
| | | (petroleum) | 3 |

### Carrier Materials f) for WGs

Fillers and carrier materials f) in the formulations according to the invention are selected from the group comprising minerals, carbonates, sulfates and phosphates of alkaline earth metals and alkali metals, such as calcium carbonate, polymeric carbohydrates, framework silicates, such as precipitated silicas having low absorption, and natural framework silicates, such as kaolin. Typical representatives of suitable fillers f) are, for example, Agsorb® LVM®-GA (attapulgite), Harborlite® 300 (pearlite), Collys® HV (modified starch), Omya® chalk (calcium carbonate), Kaolin® Tec 1 (kaolin, aluminum hydrosilicate), Steamic® OOS (talc, magnesium silicate). For c2), preference is given here to natural framework silicates and calcium carbonate products such as Omya® chalk (calcium carbonate), Kaolin Tec 1® (kaolin) and Harborlite® 300 (pearlite), particular preference to natural framework silicates such as Kaolin®, Tec® 1 (kaolin, aluminum hydrosilicate) and Harborlite® 300 (pearlite). For WG formulations, very particular preference is given to using kaolin and calcium carbonate. Further suitable carrier materials or fillers f) are selected from the group of the highly absorptive carriers having an absorption capacity of at least 200 g of dibutyl phthalate per 100 g of carrier material. Preferred highly absorptive carriers f) are silicas, for example Sipemat® products (synthetic precipitated silica of high absorptivity) and fumed silica (Aerosil® products). Preference is given to precipitated silica. The proportion of the fillers f) in the TCs according to the invention is preferably 0.1% to 10% by weight, particularly preferably 0.3% to 8% by weight and very particularly preferably 1% to 7% by weight.

### Thickeners g)

Useful thickeners g) include organic thickeners g1) and inorganic thickeners g2).

Useful organic thickeners g1) include organic natural or biotechnologically modified or organic synthetic thickeners. Typical synthetic thickeners are Rheostrux® (Croda) or the Thixin® or Thixatrol® series (Elementis). These are typically based on acrylates. Typical organic thickeners are based on xanthan or cellulose (for instance hydroxyethyl or carboxymethyl cellulose) or a combination thereof. Further typical representatives are based on lignin (such as lignosulfonates, Borresperse®NA, REAX® 88 or Kraftsperse 25 S). Preference is given to using natural modified thickeners based on xanthan. Typical representatives are, for example, Rhodopol® (Solvay) and Kelzan® (Kelco Corp.), and also Satiaxane® (Cargill).

The proportion of the organic thickeners g1) in the SCs according to the invention B) is not more than 5% by weight, preferably 0.01% to 1.0% by weight, more preferably 0.01% to 0.6% by weight, even more preferably 0.05% to 0.5% by weight and even more preferably 0.1% to 0.3% by weight.

Suitable inorganic thickeners g2) are, for example, modified natural silicates such as chemically modified bentonites, hectorites, attapulgites, montmorillonites, smectites or other silicate minerals such as Bentone® (Elementis), Attagel® (Engelhard), Agsorb® (Oil-Dri Corporation) or Hectorite® (Akzo Nobel), or the Van Gel series (R.T. Vanderbilt).

The proportion of inorganic thickeners g2) in the formulations according to the invention is 0% to 5% by weight, preferably 0.1% to 3% by weight, more preferably 0.2% to 1.5% by weight, even more preferably 0.3% to 1.5% by weight and even more preferably 0.4% to 1.3% by weight.

Preference is given to using a mixture of thickener g1) and g2). In the case of Scs, particular preference is given to using exclusively organic thickeners d1). Very particular preference is given to those thickeners g1) based on xanthan (such as Rhodopol® G from Solvay).

### Further Components h)

In addition, the SCs or TCs or WGs according to the invention may optionally also comprise, as further components h):

wetting agents, pH adjusters, defoamers, biocides, disintegrants, adhesion promoters, antifreezes, preservatives, dyes or fertilizers, and surfactants other than component c).

Suitable defoamers are surface-active silicone- or silane-based compounds such as the Tegopren® products (Goldschmidt), the SE® products (Wacker), and the Bevaloid® (Kemira), Rhodorsil® (Solvay) and Silcolapse® products (Blustar Silicones), preference being given to SE® (Wacker), Rhodorsil® and Silcolapse® products, particular preference, for example, to products such as Silcolapse® 5020.

Suitable antifreezes are those from the group of the ureas, diols and polyols, such as ethylene glycol and propylene glycol, glycerol, preferably propylene glycol or glycerol.

Suitable preservatives are, for example, products such as Acticide® MBS (Biozid, Thor Chemie), CIT, MIT or BIT, for instance Proxel® GXL (BIT), Acticide® SPX (MIT, CIT).

Suitable adhesion promoters may be selected from the group of polyvinylpyrrolidone (PVP), polyvinyl alcohol, copolymer of PVP and dimethylaminoethyl methacrylate, butylated PVP, copolymer of vinyl chloride and vinyl acetate, sodium salt of the copolymer of propenesultanic acid and partially hydrolyzed vinyl acetate, sodium caseinate, phenol resins, modified cellulose types, for example Luviskol® (polyvinylpyrrolidone), Mowiol® (polyvinyl alcohol), modified cellulose.

Suitable anti-foaming agents may be selected from the group of the esters of phosphoric acid with lower alcohols, C₆-C₁₀ alcohols, silicone surfactants (suspoemulsions of hydrophobized silica particles in aqueous emulsion concentrates based on liquid silicone surfactants), such as polydimethylsiloxane, and the absorbates thereof onto solid carrier material, for example Rhodorsil® 432 (silicone surfactant), butyl phosphate, isobutyl phosphate, n-octanol, Wacker ASP15 (polydimethylsiloxane, absorbed on solid carrier), Antifoam®SE (polydimethylsiloxane). Preference is given to suspoemulsions of hydrophobized silica particles in aqueous emulsion concentrates based on liquid silicone surfactants, such as Antifoam® SE (polydimethylsiloxane), and solid antifoams, such as Wacker ASP 15 (polydimethylsiloxane).

Further additives h) which may be present in the formulations of the invention are penetrants, wetting agents, spreading agents and/or retention agents. Suitable substances are all of those which can typically be used for this purpose in agrochemicals.

Suitable additives h) are, for example,
ethoxylated branched alcohols (e.g. Genapol® X type) with 2-20 EO units;
ethoxylated branched alcohols with terminal methyl (e.g. Genapol® XM type) with 2-20 EO units;
ethoxylated coconut alcohols (e.g. Genapol® C types) with 2-20 EO units;
ethoxylated C12/15 alcohols (e.g. Synperonic® A types) with 2-20 EO units;
propoxy-ethoxylated alcohols, branched or linear, e.g. Antarox® B/848, Atlas® G5000, Lucramul® HOT 5902;
propoxy-ethoxylated fatty acids with terminal methyl, e.g. Leofat® OC0503M;
organomodified polysiloxanes, e.g. BreakThru® OE444, BreakThru® S240, Silwett® L77, Silwett® 408;
mono- and diesters of sulfosuccinate sodium salts with branched or linear alcohols having 1-10 carbon atoms;
ethoxylated diacetylenediols (e.g. Surfynol®).

TABLE 2
Illustrative trade names and CAS numbers of preferred compounds h)

| Trade name | Company | General description | CAS No. |
|---|---|---|---|
| Lucramul ® | Levaco | Alcohol ethoxylate- | 64366- |
| HOT | | propoxylate (C8-PO8/EO6) | 70-7 |
| 5902 | | | |
| Genapol ® | Clariant | Alcohol ethoxylate (iso-C13- | 9043-30- |
| X060 | | EO6) | 5 |
| Genapol ® | Clariant | Alcohol ethoxylate (iso-C13- | 345642- |
| XM060 | | EO6/with Me end group) | 79-7 |
| Triton ® GR | Dow | Dioctylsulfosuccinate, | 577-11-7 |
| 7 ME | | sodium salt | |
| BreakThru ® | Evonik | Siloxanes and silicones, | 191044- |
| OE 444 | Industries | cetyl-Me, di-Me | 49-2 |
| BreakThru ® | Evonik | Polyether-modified | 134180- |
| S240 | Industries | trisiloxane | 76-0 |
| Silwett ® L77 | Momentive | Polyalkylene oxide-modified | 67674- |
| | | heptamethyltrisiloxane | 67-3 |
| Silwett ® 408 | Momentive | Polyalkylene oxide-modified | 67674- |
| | | heptamethyltrisiloxane | 67-3 |
| Antarox ® | Solvay | Oxirane, methyl-, polymer | 9038- |
| B/848 | | with oxirane, monobutyl | 95-3 |
| | | ether | |
| Atlas ® | Croda | Oxirane, methyl-, polymer | 9038- |
| G5000 | | with oxirane, monobutyl | 95-3 |
| | | ether | |
| Leofat ® | Lion | Oxirane, methyl-, polymer | 181141- |
| OC-0503M | Chemical, | with oxirane, mono-(9Z)-9- | 31-1 |
| | JP | octadecenoate, methyl ether, | |
| | | block | |
| Surfynol ® | Air | 2,4,7,9-tetramethyldec-5-yne- | 9014- |
| 440 | Products | 4,7-diol, ethoxylated | 85-1 |

Suitable defoamers h are all substances which can typically be used for this purpose in agrochemicals. Preference is given to silicone oils, silicone oil formulations, magnesium stearate, phosphinic acids and phosphonic acids. Examples are Silcolapse® 482 from Bluestar Silicones, Silfoam® SC1132 from Wacker [dimethylsiloxanes and -silicones, CAS No. 63148-62-9], SAG 1538 or SAG 1572 from Momentive [dimethylsiloxanes and -silicones, CAS-No. 63148-62-9] or Fluowet® PL 80.

Possible preservatives h are all substances which can typically be used for this purpose in agrochemicals. Suitable preservatives are, for example, formulations comprising 5-chloro-2-methyl-4-isothiazolin-3-one [CIT; CAS No. 26172-55-4], 2-methyl-4-isothiazolin-3-one [MIT, CAS No. 2682-20-4] or 1,2-benzisothiazol-3(2H)-one [BIT, CAS No. 2634-33-5]. Examples include Preventol® D7 (Lanxess), Kathon® CG/ICP (Rohm & Haas), Acticide® SPX (Thor GmbH) and Proxel® GXL (Arch Chemicals).

Suitable antioxidants h are all substances which can typically be used for this purpose in agrochemicals. Preference is given to butylhydroxytoluene [3,5-di-tert-butyl-4-hydroxytoluene, CAS No. 128-37-0] and citric acid.

Possible colorants h are all substances which can typically be used for this purpose in agrochemicals. Examples include titanium dioxide, carbon black, zinc oxide, blue pigments, red pigments and Permanent Red FGR.

Suitable inert fillers h) are all substances which can typically be used for this purpose in agrochemicals and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

The present invention further provides water-dispersible technical concentrates (TCs) based on the compositions described above, comprising
one or more anionic emulsifiers c2,
one or more nonionic emulsifiers c1),
at least one or more than one carrier material f.

The present invention likewise provides suspension concentrates (SCs) comprising
one or more anionic emulsifiers c2,
one or more nonionic emulsifiers c1,
at least one or more than one thickener g).

The present invention likewise provides ECs comprising
one or more nonionic emulsifiers c1,
at least one solvent e)

The present invention likewise provides ECs comprising
one or more nonionic emulsifiers c1,
at least one further active agrochemical ingredient, preferably a fungicide.

The present invention likewise provides ODs comprising
one or more nonionic emulsifiers c1,
one or more anionic emulsifiers c2,
at least one solvent e)
at least one thickener g)

### Application

Examples of administration forms which can be used include all the processes known as commonly used to the person skilled in the art: spraying, dipping, misting and a number of specific processes for direct treatment below or above ground of whole plants or parts (seed, root, stolons, stem, trunk, leaf), for example trunk injection in the case of trees or stem bandages in the case of perennial plants, and a number of specific indirect application processes.

The respective area- and/or object-based application rate of the crop protection compositions of a wide variety of different formulation types for control of the harmful organisms varies very greatly. In general, the application media known to the person skilled in the art to be commonly used for the respective field of use are used in the conventional amounts for this purpose, for example from several hundred litres of water per hectare in the case of standard spraying processes through a few litres of oil per hectare in the case of ‘ultra low volume’ aircraft application down to a few millilitres of a physiological solution in the case of injection processes. The concentrations of the inventive crop protection compositions in the particular application media therefore vary within a wide range and are dependent on the respective field of use. In general, concentrations known to the person skilled in the art to be commonly used for the respective field of use are used. Preferred concentrations are from 0.01% by weight to 99% by weight, more preferably from 0.1% by weight to 90% by weight.

The agrochemical formulations of the invention can be deployed, for example, in the formulation forms customary for liquid preparations, either as such or after prior dilution with water, i.e., for example, as emulsions, suspensions or solutions. Application is effected by customary methods, i.e., for example by spraying, pouring or injecting.

Depending on the nature of the active ingredient possibly present in addition to prothioconazole, the formulations of the invention are useful for controlling a large number of pests and can be used either for treatment of plant crops or else for that of inanimate material and in the household.

“Pests” or “harmful organisms” are understood here to mean all kinds of pests which can be controlled or kept under control with organic crop protection active ingredients, i.e. crop protection agents, especially fungicides and mixtures of fungicides with other crop protection agents. The term “pest” therefore encompasses organisms that are harmful to plants, especially harmful fungi and their spores, but also harmful insects, arachnids, nematodes and harmful plants. The term “control” encompasses both curative treatment, i.e. the treatment of affected plants with a formulation of the invention, and protective treatment, i.e. the treatment of plants for protection from pest infestation.

The present invention thus also relates to the use of the formulations described herein for the control of pests, especially plant pests, and to a method of controlling harmful organisms, especially plant-damaging organisms, comprising the contacting of the harmful organisms, their habitat, their hosts, such as plants and seed, and the soil, the area and the environment in which they grow or could grow, but also of materials, plants, seeds, soil, surfaces or spaces which are to be protected from attack or infestation by organisms that are harmful to plants, with an effective amount of the formulations of the invention.

A further aspect of the invention relates to the use of the formulations described herein for protection of plants including seed, especially useful plants, from infestation by harmful organisms, especially harmful fungi. The present invention thus also relates to the use of the formulations for control of plant-damaging organisms, for example harmful fungi, insects, arachnids, nematodes and harmful plants, especially for control of harmful fungi.

The formulations of the invention can be used in crop protection, particularly as foliar, seed-dressing and soil fungicides, in a manner known per se for control of phytopathogenic fungi.

Plants which can be treated with the formulations of the invention include the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion), Papilionaceae sp. (for example peas); major crop plants, such as Gramineae sp. (for example corn, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example bean, peanuts), Papilionaceae sp. (for example soybean), Solanaceae sp. (for example potatoes), Chenopodiaceae sp. (for example sugar beet, fodder beet, swiss chard, beetroot); sugar cane, poppy, olive, coconut, cacao, tobacco and useful plants and ornamental plants in garden and forest; and genetically modified varieties of each of these plants, and also the seeds of these plants.

Preference is given to using the formulations of the invention for treatment of wheat, barley, rye, soya, onions, corn and peanuts.

More particularly, it is possible in principle to use the formulations of prothioconazole of the invention to control all harmful fungi diseases which can also be controlled with the known formulations of prothioconazole. Depending on the particular mixing partner present in each case, the plant diseases are, for example, the following plant diseases:

Alternaria species on vegetables, oilseed rape, sugar beet, soybean, cereals, cotton, fruit and rice (e.g. A. solani or A. alternata on potato and other plants), Aphanomyces species on sugar beet and vegetables, Ascochyta sp. on cotton and rice, Bipolaris and Drechslera species on corn, cereals, rice and lawn (e.g. teres on barley, D. tritci-repentis on wheat), Blumeria graminis (powdery mildew) on cereals, Botrytis cinerea (gray mold) on strawberries, vegetables, flowers and grapevines, Botryodiplodia sp. on cotton, Bremia lactucae on lettuce, Cerospora species on corn, soybeans, rice and sugar beet (e.g. C. beticula on sugar beet), Cochliobolus species on corn, cereals, rice (e.g. Cochliobolus sativus on cereals, Cochliobolus miyabeanus on rice), Corynespora sp. on soybeans, cotton and other plants, Colletotrichum species on soybeans, cotton and other plants (e.g. C. acutatum on various plants), Curvularia sp. on cereals and rice, Diplodia sp. on cereals and rice, Exserohilum species on corn, Erysiphe cichoracearum and Sphaerotheca fuliginea on cucumber species, Fusarium and Verticillium species (e.g. V. dahliae) on various plants (e.g. F. graminearum on wheat), Gaeumanomyces graminis on cereals, Gibberella species on cereals and rice (e.g. Gibberella fujikuroi on rice), Grainstaining complex on rice, Helminthosporium species (e.g. H. graminicola) on corn and rice, Macrophomina sp. on soybean and cotton, Michrodochium sp. (e.g. M. nivale on cereals), Mycosphaerella species on cereals, bananas and peanuts (M. graminicola on wheat, M. fijiesis on banana), Phaeoisaripsis sp. on soybeans, Phakopsara sp. (e.g. P. pachyrhizi and P. meibomiae on soybeans), Phoma sp. on soybeans, Phomopsis species on soybeans, sunflowers and grapevines (P. viticola on grapevines, P. helianthii on sunflowers), Phytophthora infestans on potatoes and tomatoes, Plasmopara viticola on grapevines, Penecilium sp. on soybeans and cotton, Podosphaera leucotricha on apples, Pseudocercosporella herpotrichoides on cereals, Pseudoperonospora species on hops and cucumber species (e.g. P. cubenis on cucumber), Puccinia species on cereals, corn and asparagus (P. triticina and P. striformis on wheat, P. asparagi on asparagus), Pyrenophora species on cereals, Pyricularia oryzae, Corticiwn sasakii, Sarocladiwn oryzae, S. attenuatum, Entyloma oryzae on rice, Pyricularia grisea on lawn and cereals, Pythium spp. on lawn, rice, corn, cotton, oilseed rape, sunflowers, sugar beet, vegetables and other plants, Rhizoctonia species (e.g. R. solani) on cotton, rice, potatoes, lawn, corn, oilseed rape, potatoes, sugar beet, vegetables and other plants, Rynchosporium sp. (e.g. R. secalis) on rice and cereals, Sclerotinia species (e.g. S. sclerotiorum) on oilseed rape, sunflowers and other plants, Septoria tritici and Stagonospora nodorum on wheat, Erysiphe (syn. Uncinula necator) on grapevines, Setosphaeria species on corn and lawn, Sphacelotheca reilinia on corn, Thievaliopsis species on soybeans and cotton, Tilletia species on cereals, Ustilago species on cereals, corn and sugar beet, and Venturia species (scab) on apple and pear (e.g. V. inaequalis on apple).

The formulations of the invention can be applied in undiluted form or diluted with water. In general, they are diluted with at least one part water, preferably with 10 parts water and more preferably with at least 100 parts water, for example with 1 to 10 000, preferably 10 to 5000 and more preferably with 50 to 24 000 parts water, based on one part of the formulation.

The present invention likewise provides an emulsion obtainable by mixing water with the liquid formulation of the invention. The mixing ratio of water to emulsion concentrate may be in the range from 1000:1 to 1:1, preferably 400:1 to 10:1.

The dilution is achieved by pouring the emulsion concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 0° C. to 50° C., in particular at 10° C. to 30° C. or at ambient temperature.

The water used for dilution is generally tap water. The water may, however, already contain water-soluble or finely dispersed compounds which are used in crop protection, for instance nutrients, fertilizers or pesticides.

It is possible to add various kinds of oils, wetting agents, adjuvants, fertilizers or micronutrients and further pesticides (e.g. herbicides, insecticides, fungicides, growth regulators, safeners) to the emulsion of the invention in the form of a premix or, if appropriate, not until shortly before use (tank-mix). These compositions may be added to the formulations of the invention in a weight ratio of 1:100 to 100:1, preferably 1:10 to 10:1.

The user will apply the formulation of to the invention typically from a pre-dosing system, a backpack sprayer, a spraying tank, a spraying aircraft or an irrigation system. The formulation of the invention is typically diluted to the desired application concentration with water, buffer and/or further auxiliaries, which affords the ready-to-use spray liquor or agrochemical composition of the invention. Typically, 20 to 2000 litres, preferably 50 to 400 litres, of the ready-to-use spray liquor are deployed per hectare of useful agricultural area.

The required application rates of the pure active ingredients without formulation aids depend on the intensity of pest infestation, on the development phase of the plants, on the climatic conditions of the site of use and on the application method. In general, the application rate is in the range from 0.001 to 3 kg, preferably from 0.005 to 2 kg, more preferably from 0.01 to 1 kg and most preferably from 50 to 500 g of active ingredient per hectare, active ingredient here meaning prothioconazole plus possible further active ingredients.

The generally diluted formulations of the invention are applied mainly by spraying, especially spraying of the leaves. The application can be conducted by spraying techniques known to those skilled in the art, for example using water as carrier and amounts of spray liquor of about 50 to 1000 liters per hectare, for example from 100 to 00 liters per hectare.

The novel prothioconazole-containing formulations have advantageous properties in respect of the treatment of plants; more particularly, they feature good use properties, high stability and high fungicidal activity.

The invention is illustrated in detail by the examples but is not restricted thereto.

### EXAMPLES

### Feedstocks Used

The terms used in the examples below have the following meanings:

| | |
|---|---|
| prothioconazole | PTZ (Bayer AG) |
| Atlox Metasperse 500 | Croda, acrylate-based copolymer |
| Citric acid | Sigma-Aldrich |
| Vitamin C | Sigma-Aldrich, ascorbic acid |
| Vitamin E | Sigma-Aldrich, alpha-tocopherol |
| Pluronic PE 10500 | propylene oxide/ethylene oxide (PO-EO) |
| | block polymer (BASF) |
| Rhodopol ® 23 | xanthan derivative (Solvay) |
| Silcolapse ® 426 | silicone defoamer (Solvay) |
| Glycerol | antifreeze |
| Proxel ® GXL | preservative (biozide, Proxel) |
| Lucramul ® CO30 | non-ionic emulsifier, ethoxylated castor oil, |
| | Levaco Chemicals, DE |
| SAG1572 | aqueous emulsion of polydimethylsiloxane |
| | Momentive ® |
| Genagen ® 4296 | dimethyldecanamide (DAA), Clariant |

### General Preparation of an Aqueous Suspension Concentrate (SC)

First of all, water is initially charged at room temperature. The active ingredients and the other components are added (in no particular order) with stirring. The mixture is pre-comminuted in a colloid mill, followed by wet grinding using, for example, a bead mill. Finally, the organic thickener is added.

### General Preparation of an Emulsion Concentrate (EC)

The organic solvent is initially charged. All other components are then added (in no particular order) with stirring. Stirring is continued until a clear solution is formed.

### Determination of 2-(1-chlorocyclopropyl)-1-(2-chlorophenyl)-3-(1H-1,2,4-triazol-1-yl)propan-2-ol (compound III) in Formulations

2-(1-Chlorocyclopropyl)-1-(2-chlorophenyl)-3-(1H-1,2,4-triazol-1-yl)propan-2-ol is separated from the formulation constituents on a reverse phase column using an isocratic eluent. After MS/MS detection, the quantitative evaluation is conducted by comparing the peak areas with those of the reference object, using an external standard.

High-pressure liquid chromatograph: HP 1090

Sample injection: HP 1090 Autoinjector

Mass spectrometer: Quattro I, Fisons

Integration and evaluation: MassLynx from Micromass

In each case, the samples are, unless indicated otherwise, exposed to light and stored for 4 weeks.

### Example 1

### Recipe of a Prothioconazole Emulsion Concentrate Formulation (Storage in the Dark)

| | 1a | | | | | | |
|---|---|---|---|---|---|---|---|
| | (comparison) | 1b | 1c | 1d | 1e | 1f | 1g |
| | % by | % by | % by | % by | % by | % by | % by |
| Component | weight | weight | weight | weight | weight | weight | weight |
| Prothioconazole | 25 | 25 | 25 | 25 | 25 | 12.76 | 12.76 |
| Lucramul CO 30 | 20 | 20 | 20 | 20 | 20 | 7.5 | 7.5 |
| SAG1572 | 0.1 | 0.1 | 0.1 | 0.1 | 0.1 | 0.1 | 0.1 |
| Genagen ® 4296 | 54.90 | 53.90 | 51.90 | 49.90 | 44.90 | 54.39 | |
| Hallcomid 1025 | | | | | | | 54.39 |
| alpha-Tocopherol | 0 | 1 | 3 | 5 | 10 | 5 | 5 |
| (according to the | | | | | | | |
| invention) | | | | | | | |
| tebuconazole | 0 | 0 | 0 | 0 | 0 | 12.76 | 12.76 |
| Soprophor 796/P | 0 | 0 | 0 | 0 | 0 | 7.5 | 7.5 |

### Rapid Storage Results

| | CIPAC | 1a | 1d | 1e |
|---|---|---|---|---|
| Emulsion stability 0 h/1 h/24 h | MT 36.3 | ok | ok | ok/trace of |
| | | | | crystals/2 |
| | | | | ml |
| | | | | sediment |
| Emulsion stability 0 h/1 h/24 h | | ok | ok | ok/trace of |
| after 2 weeks of storage at 54° C. | | | | crystals/2 |
| | | | | ml |
| | | | | sediment |
| pH, 1% in distilled water | MT 75.3 | 5.56 | 5.32 | 5.36 |
| pH, 1% in distilled water after 2 | | 5.38 | 5.25 | 5.48 |
| weeks of storage at 54° C. | | | | |
| Appearance, viscosity, separation | | ok | ok | turbidity |
| Appearance, viscosity, separation | | ok | ok | yellow |
| after 2 weeks of storage at 54° C. | | | | turbidity |
| Proportion of compound III after | 40 | 40 | 40 | 40 |
| 0 h | ppm | ppm | ppm | ppm |
| Proportion of compound III after | 900 | 80 | 80 | 80 |
| irradiation | ppm | ppm | ppm | ppm |
| with 460 nm LED, 24 h and 10% | | | | |
| air over the sample | | | | |

As shown in Example 1e, at a concentration of 10% vitamin E unwanted effects (crystallisation, sedimentation) occur in the formulation, whereas a positive effect on the reduction of compound III can be measured even at a content of 1% vitamin E in the formulation.

Example 1f was stored for 4 weeks at room temperature in a vessel filled only up to about 10%, at a clear laboratory window. Even under these untypical conditions (exposure to air and light), the proportion of compound III remained at 21 ppm and thus considerably below the permitted EU threshold of 62.5 ppm.

### Example 2

### Recipe of a Prothioconazole Suspension Concentrate

| | 2a | | | |
|---|---|---|---|---|
| | (comparison) | 2b | 2c | 2d |
| | % by | % by | % by | % by |
| Component | weight | weight | weight | weight |
| Prothioconazole | 41 | 41 | 41 | 41 |
| Pluronic PE 10500 | 3 | 3 | 3 | 3 |
| Atlox Metasperse | 1 | 1 | 1 | 1 |
| 500 | | | | |
| glycerol | 6 | 6 | 6 | 6 |
| Silcolapse 426R | 0.1 | 0.1 | 0.1 | 0.1 |
| Proxel GXL | 0.2 | 0.2 | 0.2 | 0.2 |
| Rhodopol G | 0.24 | 0.24 | 0.24 | 0.24 |
| Water | 48.46 | 49.36 | 48.16 | 45.46 |
| ascorbic acid | 0 | 0.1 | 0.3 | 3 |

### Rapid Storage Results

| | CIPAC | 2a | 2c | 2d |
|---|---|---|---|---|
| Suspendability | MT 184 | ok | ok | ok |
| Suspendability after 2 weeks | MT 184 | ok | ok | ok |
| of storage at 54° C. | | | | |
| Wet screening 150 μm sieve | MT 185 | ok | ok | ok |
| Wet screening 150 μm sieve | MT 185 | ok | ok | ok |
| after 2 weeks of storage at | | | | |
| 54° C. | | | | |
| Particle size d90 in μm | MT 187 | 3 | 3 | 3 |
| Particle size d90 in μm after | MT 187 | 4 | 4 | 4 |
| 2 weeks of storage at 54° C. | | | | |
| Appearance, viscosity, | ok | ok | ok | |
| separation | | | | |
| Appearance, viscosity, | ok | ok | ok | |
| separation after 2 weeks of | | | | |
| storage at 54° C. | | | | |
| Proportion of compound III | 40 ppm | 40 ppm | 40 ppm | 40 ppm |
| after 0 h | | | | |
| Proportion of compound III | 245 ppm | 45 ppm | 45 ppm | 45 ppm |
| after irradiation with 460 nm | | | | |
| LED, 24 h and 10% air over | | | | |
| the sample | | | | |

Up to a proportion of 3% vitamin C in the formulations, there was no detrimental change of the properties of the formulations. Even at a content of 0.1% vitamin C, it was possible to achieve a positive effect with respect to the reduction of compound III.

### Example 3

### Recipe of a Prothioconazole Oil Dispersion (with Vitamin E)

| | 3a | | | | |
|---|---|---|---|---|---|
| | (comparison) | 3b | 3c | 3d | 3e |
| | % by | % by | % by | % by | % by |
| Component | weight | weight | weight | weight | weight |
| bixafen | 6.13 | 6.13 | 6.13 | 6.13 | 6.13 |
| Prothioconazole | 12.25 | 12.25 | 12.25 | 12.25 | 12.25 |
| Tanemul Hot | 7.5 | 7.5 | 7.5 | 7.5 | 7.5 |
| 5902 | | | | | |
| Emulsogen EL | 5 | 5 | 5 | 5 | 5 |
| 400 | | | | | |
| Triton GR 7 ME | 5 | 5 | 5 | 5 | 5 |
| Rhodacal 60 BE | 5 | 5 | 5 | 5 | 5 |
| Morwet D-425 | 2 | 2 | 2 | 2 | 2 |
| Aerosil R 812 S | 0.5 | 0.5 | 0.5 | 0.5 | 0.5 |
| Aerosil 200 | 0.7 | 0.7 | 0.7 | 0.7 | 0.7 |
| Silfoam SC 1132 | 0.05 | 0.05 | 0.05 | 0.05 | 0.05 |
| Vitamin E | 0 | 0.1 | 0.3 | 0.5 | 1 |
| Rapeseed oil | ad 100 | ad 100 | ad 100 | ad 100 | ad 100 |
| methyl ester | | | | | |

### Rapid Storage Results

| | CIPAC | 3a | 3c | 3d | 3e |
|---|---|---|---|---|---|
| Dispersibility | MT 180 | ok | ok | ok | ok |
| Dispersibility after 2 weeks of | MT 180 | ok | ok | ok | ok |
| storage at 54° C. | | | | | |
| Wet screening 150 μm sieve | MT 185 | ok | ok | ok | ok |
| Wet screening 150 μm sieve after | MT 185 | ok | ok | ok | ok |
| 2 weeks of storage at 54° C. | | | | | |
| Particle size d90 in μm | MT 187 | 15 | 15 | 15 | 15 |
| Particle size d90 in um after 2 | MT 187 | 20 | 20 | 20 | 20 |
| weeks of storage at 54° C. | | | | | |
| Appearance, viscosity, separation | | ok | ok | ok | ok |
| Appearance, viscosity, separation | | ok | ok | ok | ok |
| after 2 weeks of storage at 54° C. | | | | | |
| Proportion of compound III after | 11 | 11 | 11 | 11 | |
| 0 h | ppm | ppm | ppm | ppm | |
| Proportion of compound III after | 540 | 240 | 89 | 71 | 15 |
| 2 weeks of storage under light | ppm | ppm | ppm | ppm | ppm |
| and 10% air over the sample | | | | | |

Even small amounts of vitamin E stabilise prothioconazole under light and reduce the formation of compound III in an OD formulation.

### Example 4

Effects of UV Blockers

Table Entry 1:

0.4 g of prothioconazole and 1.6 g of N,N-dimethyldecanamide were combined in a 20 ml vial.

Table Entry 2:

As Table entry 1, with 60 mg of octocrylene added.

Table Entry 3:

0.4 g of prothioconazole, 1.6 g of acetonitrile and 0.78 g of acetone were combined in a 20 ml vial.

All reaction mixtures were irradiated in a photoreactor with stirring (magnetic stirrer) using LED lamps (wavelength 450 nm, 47 mW/cm²) for 24 hours. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

| | | Proportion of |
|---|---|---|
| | Experiment | dethio in ppm |
| 1 | prothioconazole in DAA (purity, 98%) | 1892 |
| 2 | prothioconazole in DAA (purity, 98%) | 795 |
| | with octocrylene | |
| | (3% by weight) | |
| 3 | prothioconazole in high-purity | 1088 |
| | acetonitrile/acetone mixture (2:1 g/g) | |

Even in pure DAA and in combination with a UV blocker, on irradiation a significant proportion of dethio is formed, as in pure solvents (acetonitrile/acetone).

### Example 5

### Effect of 5% by Weight Additives on Prothioconazole in N,N-dimethyldecanamide

0.4 g of prothioconazole, 1.5 g of N,N-dimethyldecanamide and 0.1 g of the respective stabiliser were combined in a 20 ml vial. The reaction mixtures were irradiated in a photoreactor with stirring (magnetic stirrer) using LED lamps (wavelength 350 nm, 19 mW/cm²) for 24 hours. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

| | Compound |
|---|---|
| Antioxidant | III (ppm) |
| Comparison | 1539 |
| (+)-delta-Tocopherol | 81 |
| (+/−)-alpha-Tocopherol | 96 |
| Thiolactic acid | 357 |
| Butylated hydroxytoluene (BHT) | 576 |
| Eugenol | 580 |
| Caffeic acid | 616 |
| Mercaptopropionic acid | 630 |
| DL-Dithiothreitol | 749 |
| Sunflower oil | 994 |
| N-(Mercaptopropionyl)glycine | 1102 |
| Octocrylene | 1377 |
| Rapeseed oil | 1513 |
| 4-Methoxyphenol | 1706 |
| Ferulic acid | 2059 |
| PEG-substituted tocopherol | 2454 |
| 4-Hydroxycinnamic acid | 2754 |
| Gallic acid | 3700 |

As can be seen from the table above, not all antioxidants lead to a stabilisation of prothioconazole with respect to a reduction of dethio formation. Rather, some of them even appear to have a negative effect (increased dethio formation).

### Example 6

### 20% Prothioconazole with DAA

A quantity of (+/−)-alpha-tocopherol (see table below) was added to clear 50 ml glass bottles and the content was then made up to a total weight of 5 g using a solution of 20% by weight of prothioconazole in N,N-dimethyldecanamide. The bottles were shaken and, in an outdoor trial, exposed to direct sunlight for 2 weeks. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

EC250 Formulation of prothioconazole:

| Amount of | % by weight | Compound |
|---|---|---|
| tocopherol (mg) | of tocopherol | III (ppm) |
| 270 | 5% | 11 |
| 158 | 3% | 18 |
| 62 | 1% | 57 |
| 0 | 0% | 552 |

A quantity of (+/−)-alpha-tocopherol (see table below) was added to clear 50 ml glass bottles and the content was then made up to a total weight of 5 g using an EC250 formulation of prothioconazole. The bottles were shaken and, in an outdoor trial, exposed to direct sunlight for 2 weeks. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

| Amount of | | |
|---|---|---|
| tocopherol | % by weight | Compound |
| (mg) | of tocopherol | III (ppm) |
| 267 | 5% | 44 |
| 156 | 3% | 60 |
| 52 | 1% | 230 |
| 0 | 0% | 1253 |

As shown by the experiments described above, even on addition of 1 per cent by weight of (+/−)-alpha-tocopherol, based on the total weight of the composition, both in an EC250 formulation and in a solution of 20% by weight of prothioconazole in DAA, the formation of compound III in an outdoor trial was significantly reduced, with the effect being even more pronounced when the concentration was increased to 3 per cent by weight of tocopherol.

### Example 7

2 g of an SC325 (Fox325) formulation and an SC450 formulation (XPRO SC 450) of prothioconazole were combined with the amount of vitamin C stated in the table below in a 20 ml vial. The reaction mixtures were irradiated in a photoreactor with stirring (magnetic stirrer) using LED lamps (wavelength 450 nm, 47 mW/cm²) for 24 hours. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

| | Amount of | % by | |
|---|---|---|---|
| | vitamin C | weight of | Compound |
| | (mg) | vitamin C | III (ppm) |
| FOX SC325 | 0 | 0 | 353 |
| (16% PTZ + | 2 | 0.1 | 101 |
| 14% | 6 | 0.3 | 85 |
| trifloxystrobin | 10 | 0.5 | 77 |
| in water) | 14 | 0.7 | 75 |
| | 20 | 1 | 64 |
| | 60 | 3 | 47 |
| | 100 | 5 | 42 |
| FoX XPRO | 0 | 0 | 173 |
| Sc 450 | 2 | 0.1 | 117 |
| (14.8% PTZ + | 6 | 0.3 | 53 |
| 12.7% | 10 | 0.5 | 50 |
| trifloxystrobin + | 14 | 0.7 | 48 |
| 10.6 % | 20 | 1 | 33 |
| bixafen in | 60 | 3 | 27 |
| water) | 100 | 5 | 36.5 |

As shown by the experiments above, vitamin C protects SC formulations of prothioconazole very efficiently even with only 0.1 per cent by weight added. Up to a content of 3% by weight of vitamin C, the effect increases with increasing vitamin C content.

### Example 8

2 g of the EC formulation stated in the table (dispersant: N,N-dimethyldecanamide) were combined with 1 or 3 per cent by weight of (+/−)α-tocopherol in a 20 ml vial. The reaction mixtures were irradiated in a photoreactor with stirring (magnetic stirrer) using LED lamps (wavelength 365 nm, 19 mW/cm²) for 24 hours. Samples were then taken and the respective content of compound III was determined by HPLC chromatography (column: Agilent Zorbax Eclipse Plus C18, 50×4.6 mm, 1.8 μm, mobile phase: acetonitrile/0.1% by weight of aqueous phosphoric acid, gradient at 2 ml/min, temperature: 45° C., external standard).

| | Composition | % | |
|---|---|---|---|
| | active | by weight | Compound |
| | ingredients | of (+/−)α- | III |
| Formulation | (% by weight) | tocopherol | (ppm) |
| Ascra Xpro | 12% PTZ, | 0 | 2189 |
| EC260 | 6% bixafen, | | |
| | 6% fluopyram | | |
| Ascra Xpro | 12% PTZ, | 1 | 258 |
| EC260 | 6% bixafen, | | |
| | 6% fluopyram | | |
| Ascra Xpro | 12% PTZ, | 3 | 126 |
| EC260 | 6% bixafen, | | |
| | 6% fluopyram | | |
| Input Xpro | 10% PTZ, 25% | 0 | 205 |
| EC400 | spiroxamine, 5% | | |
| | bixafen | | |
| Input Xpro | 10% PTZ, 25% | 1 | 140 |
| EC400 | spiroxamine, 5% | | |
| | bixafen | | |
| Input Xpro | 10% PTZ, 25% | 3 | 150 |
| EC400 | spiroxamine, 5% | | |
| | bixafen | | |
| Tilmor | 8% PTZ, 16% | 0 | 1190 |
| EC240 | tebuconazole | | |
| Tilmor | % PTZ, 16% | 1 | 219 |
| EC240 | tebuconazole | | |
| Tilmor | % PTZ, 16% | 3 | 115 |
| EC240 | tebuconazole | | |

As shown by the experiments above, the formation of dethio can also be reduced significantly in commercial prothioconazole-containing formulations by addition of (+/−)α-tocopherol.

1. A formulation, comprising
a) an active ingredient having a thione group and
b) at least one antioxidant selected from the group comprising ascorbic acid, tocotrienol, tocopherols (e.g. (+)-delta-tocopherol, (+/−)-alpha-tocopherol), mixtures of tocopherols, thiolactic acid, BHT, eugenol, caffeic acid (3,4-dihydroxycinnamic acid), mercaptopropionic acid and D,L-thiothreitol.

2. The formulation according to claim 1, wherein the antioxidant is selected from the group comprising ascorbic acid, tocotrienol, tocopherols and mixtures thereof.

3. The formulation according to claim 1, wherein the formulation is an aqueous formulation with ascorbic acid as antioxidant.

4. The formulation according to claim 1, wherein the formulation is a formulation based on an organic solvent and the antioxidant is selected from the group comprising tocotrienols and tocopherols and mixtures thereof.

5. The formulation according to claim 1, wherein the active ingredient a) is selected from the group comprising prothioconazole and 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile.

6. The formulation according to claim 1, wherein the active ingredient a) is prothioconazole.

7. The formulation according to claim 1, wherein the proportion of component a) is 1% by weight to 50% by weight.

8. The formulation according to claim 1, wherein the proportion of component b) is 0.01% by weight to 15.00% by weight.

9. The formulation according to claim 1, comprising an aqueous SC formulation and the proportion of component b) is 0.01% by weight to 10.00% by weight.

10. The formulation according to claim 1, comprising a non-aqueous EC or OD formulation and the proportion of component b) in an EC formulation is optionally 0.05% by weight to 15.00% by weight and the proportion of component b) in an OD formulation is optionally 0.1% by weight to 5.00% by weight.

11. The formulation according to claim 1, wherein said formulation comprises at least one of the following components:
c) c1: non-ionic dispersant/emulsifier,
c2: ionic dispersant/emulsifier
d) one or more other active agrochemical ingredients different from a)
e) one or more solvents including OD carriers
f) one or more carriers (WGs, and Aerosils for SC/TC/WG)
g) g1: one or more organic thickeners
g2: one or more inorganic thickeners
h) one or more further additives and auxiliaries.

12. The formulation according to claim 11, comprising a nonionic (c1) and/or anionic (c2) emulsifier.

13. The formulation according to claim 11, wherein said one or more active agrochemical ingredients d) comprise one or more active insecticidal or fungicidal ingredients.

14. The formulation according to claim 11, wherein the further active agrochemical ingredient d) is bixafen.

15. The formulation according to claim 11, comprising not more than 5% by weight of water.

16. The process for preparing the formulation according to claim 1 comprising mixing components a) and b) and optionally one or more further additives.

17. A method for controlling one or more harmful organisms, comprising contacting of the harmful organisms, a habitat thereof, one or more hosts, optionally plants and seed, and/or soil, an area and/or an environment in which plants grow or could grow, and/or one or more materials, plants, seeds, soil, surfaces or spaces which are to be protected from attack or infestation by organisms that are harmful to plants, with an effective amount of a formulation according to claim 1.

18. A product comprising the formulation according to claim 1 for protection of one or more plants including seed, optionally useful plants, from infestation by one or more harmful organisms.

19. A product comprising the formulation according to claim 1 for control of one or more organisms that are harmful to plants, optionally one or more phytopathogenic harmful fungi, insects, arachnids, nematodes and harmful plants.

20. The product according to claim 19, wherein the harmful organisms are phytopathogenic harmful fungi.

21. An emulsion, obtainable by mixing water with one or more formulations according to claim 1, wherein a mixing ratio of water to emulsion concentrate is in a range from 1000:1 to 1:1.
